(19) United States
(12) Patent Application Publication
(10) Pub. No.: US 2026/0105510 A1
(43) Pub. Date: Apr. 16, 2026

(54) AUTOMATED SUBSTITUTION FOR ORDERS

(71) Applicant: Target Brands, Inc., Minneapolis, MN (US)

(72) Inventors: Cody Mehlhorn, Minneapolis, MN (US); Jathin Jayan, Minneapolis, MN (US); Theodore Nelson, Minneapolis, MN (US); Brian Andrade, Minneapolis, MN (US)

(21) Appl. No.: 19/355,387

(22) Filed: Oct. 10, 2025

Related U.S. Application Data
(60) Provisional application No. 63/706,257, filed on Oct. 11, 2024.

(51) Int. Cl. G06Q 30/0601

(52) U.S. Cl. CPC G06Q 30/06313; G06Q 30/0633

(57) ABSTRACT

The disclosed technology provides for substituing items for an order fulfillment system. A method can include receiving, by a server system, order information from computing device for picking up an order at a fulfillment location indicating multiple items. The method further includes receiving, by the computing device, substitution option information from the server system for at least a subset of the multiple items of the order. The substitution option information indicates one or more substitution options for each of the subset of the multiple items. The method further includes receiving, by the server system, a second communication from the computing device indicating a selection of a substitution option for at least one item of the subset of the multiple items, and changing a display of the computing device to display a confirmation option selection based on receiving the substitution confirmation information.

### CROSS-REFERENCE TO RELATED APPLICATIONS

This application claims the benefit of U.S. Provisional Application Ser. No. 63/706,257, filed on Oct. 11, 2024. The contents of this aforementioned application are fully incorporated herein by reference.

### TECHNICAL FIELD

This document generally relates to architecture of computer systems, communications between computing devices, and graphic user interfaces for eliciting user input.

### BACKGROUND

Computing devices are devices that accept data input, process the data, and provide data output using hardware and software. Computing devices can communicate with other computing devices using wired or wireless networks or a combination thereof. For example, computing devices can communicate over the Internet. User interactions with a computing device can cause the computing device to transmit communications to a second computing device, which can cause the second computing device to provide output such as changes to a visual display, sounds, or tactile output. Such output at the second computing device can elicit user input from a user of the second computing device, which can in turn cause the second computing device to transmit one or more communications to the first computing device thereby causing the first computing device to generate additional output.

### SUMMARY

This document generally describes a network based order fulfillment system that allows users, such as customers, to substitute one or more items for an order. More particularly, the disclosed technology provides techniques for allowing a user to select from multiple substitution options for an item based on an availability of the item at a fulfillment location. For example, a first user device can collect user input and other information using one or more sensors of the user device to identify items that a first user wishes to purchase from a store, alternative substitute fulfillment options for the selected items, and other information about the first user and the first user's order. The first user's device can provide this information to a server system that subsequently provides relevant information to a user device of a worker at a fulfillment location to allow the worker to fulfill the order in a timely manner, identify relevant substitute items for items that are unavailable, and provide the items in the order to the first user upon arrival of the first user at the fulfillment location. The worker can interact with her user device to cause the worker's device to update a status of the order and provide information to the first user's device which can cause the first user's device to provide additional information to the first user.

In some implementations, receiving, by the first computing device, the substitution option information from the server system for at least a subset of the multiple items of the order includes identifying each item of the subset of the multiple items based on an availability of the item at the fulfillment location.

In some implementations, the one or more substitution options for each item of the subset of the multiple items based on eligibility of the substitution associated with a type of the item.

In some implementations, the one or more substitution options include a first substitution option for the first user to select a substitute item for an identified item from multiple items available at the fulfillment location, a second substitution option for a second user to select a substitute item for the identified item from multiple items available at the fulfillment location, wherein the second user is associated with the fulfillment location, a third substitution option to refrain from selecting a substitute item for the identified item, or a combination thereof.

In some implementations, receiving, by the server system, a second communication from the first computing device indicating a selection of a substitution option of the one or more substitution options for each at least one of the subset of the multiple items includes selecting, by the first user, a substitution option for each of the subset of the multiple items, and receiving, by the server system, order placement information from the first computing device, where the order placement information includes the multiple items and the indications of the substitution option selections.

In some implementations, the method further includes receiving, by a second computing device, the order placement information of the first user from the server system, where the second computing device is associated with the second user at the fulfillment location.

In some implementations, receiving, by the second computing device, the order placement information of the first user from the server system includes receiving, by the second computing device, the order placement information indicating one or more selections of the second substitution option for one or more items of the subset of the multiple items, and selecting, by the second user, for each item, the substitute item at the fulfillment location based on one or more substitution factors, and transmitting, to the first computing device, the substitution confirmation information for each of the at least one item of the subset of the multiple items, where the substitution confirmation information indicates each substitute item selected by the second user for the order.

In some implementations, the one or more substitution factors include a type of the item, a quantity of the item, a cost of the item, or a combination thereof.

In some implementations, the method further includes selecting, by a first user, an item substitution confirmation option for each substitute item selected by the second user for the order, receiving, by the second computing device, the item substitution confirmation option, and preparing, by the second user, the order for the first user based on the order information and the item substitution confirmation option.

In some implementations, selecting, by the first user, an item substitution confirmation option for each substitute item selected by the second user for the order includes selecting, by the first user, to confirm the substitute item selected by the second user for the order, where the confirming indicates to substitute the item with the substitute item selected by the second user.

In some implementations, selecting, by the first user, an item substitution confirmation option for each substitute item selected by the second user for the order includes selecting, by the first user, to reject the substitute item selected by the second user for the order, where the rejecting indicates to refrain from substituting the item with the substitute item selected by the second user.

In some implementations, the method further includes maintaining substitution information for each order, where the substitution information indicates, for each item, the selected substitution option.

In some implementations, the substitution information further indicates, the substitute item selected by the first user based on a selection of the first substitution option, the substitute item selected by the second user based on a selection of the second substitution option, or both.

In some implementations, the substitution information further indicates, for each substitute item selected by the second user, the item substitution confirmation option selected by the first user for the substitute item selected by the second user.

In some implementations, the method further includes receiving, by the server system, a fourth communication from the first computing device indicating that the first computing device has arrived at the fulfillment location to pick up the order.

In some implementations, the order information includes an identifier associated with the account of the first user.

The system can optionally include one or more of the abovementioned features.

The devices, system, and techniques described herein may provide one or more of the following advantages. For example, the disclosed techniques provide for allowing users to substitute one or more items for an order. In particular, the disclosed techniques provide users with multiple substitution options for a particular item based on an availability of the item at the fulfillment location. That is, a user can add one or more items to an online cart, and the user interface can generate a display that notifies the user i) whether an item is low in stock and ii) one or more substitution options. For example, if the selected item is not available, the substitution options can include that a shopper can substitute for a “best option,” the user can indicate a substitute for the item, or the user can indicate to not select substitutions for the item.

In the case where the user indicates for a shopper to substitute for the best option, the user interface can generate a display that notifies the user of the substitutions, and the user can accept or reject the substitutions based on the notification. The user can then confirm the substitutions prior to picking up the order from the location.

In some examples, the user can select a substitution preference for all items or select a substitution preference for each individual item. Additionally, in some examples, the system can maintain a record of substitutions selections, and the system can present the substitutions as an option for a next order of a particular user. The system can also indicate an eligibility of the substitution associated with a type of the item.

By implementing these substitution methods, the order fulfillment process can therefore be performed accurately and efficiently to decrease delays in the substitution process. That is, by allowing a user to more easily replace items when selected items are not available, the described can increase the efficiency of users selecting substitutions for the items, thereby leading to improved outcomes with respect to efficiency and accuracy of both user interactions with the mobile computing devices and fulfillment of orders. Moreover, by maintaining a record of substitution selections, the system can efficiently suggest substitutions to the user for future orders.

Furthermore, systems, devices, program products, and processes described throughout this document can, in some instances, provide one or more of the following advantages. By providing streamlined communications between mobile devices operated by users/customers and employees working at fulfillment locations, an order fulfillment system can reduce the amount of time spent interacting with the mobile devices, thereby reducing power consumption and improving battery life of the computing devices. Additionally, by streamlining communications while providing for computer network based ordering and pick-up facilitation in selecting substitutions, the computing system can reduce the amount of communications to and from mobile computing devices, thereby reducing bandwidth usage of one or more communications networks and freeing up communications bandwidth for other purposes. Additionally, unique user interface elements at mobile computing devices of both users/customers and employees of fulfillment locations can improve user experience thereby leading to improved outcomes with respect to efficiency and accuracy of both user interactions with the mobile computing devices and fulfillment of orders. By increasing the efficiency of user interaction with multiple devices, the invention saves power in the system by reducing the amount of time that screen devices need to be powered on to present graphic user interfaces and by reducing the amount of time that various sensors need to be in use to receive user input. Other benefits and advantages will be apparent from the following descriptions.

The details of one or more implementations are set forth in the accompanying drawings and the description below. Other features and advantages will be apparent from the description and drawings, and from the claims.

### BRIEF DESCRIPTION OF THE DRAWINGS

FIG. 1 is diagram of an example system for facilitating item substitutions for user order fulfillment.

FIGS. 2A-2H show example user interface displays for computing devices in facilitating item substitutions for the order fulfillment system.

FIG. 3 is a flowchart of an example process to be performed by a computing device in an order fulfillment system.

FIG. 4 is a schematic diagram that shows an example of a computing device and a mobile computing device.

Like reference symbols in the various drawings indicate like elements.

### DETAILED DESCRIPTION OF ILLUSTRATIVE EMBODIMENTS

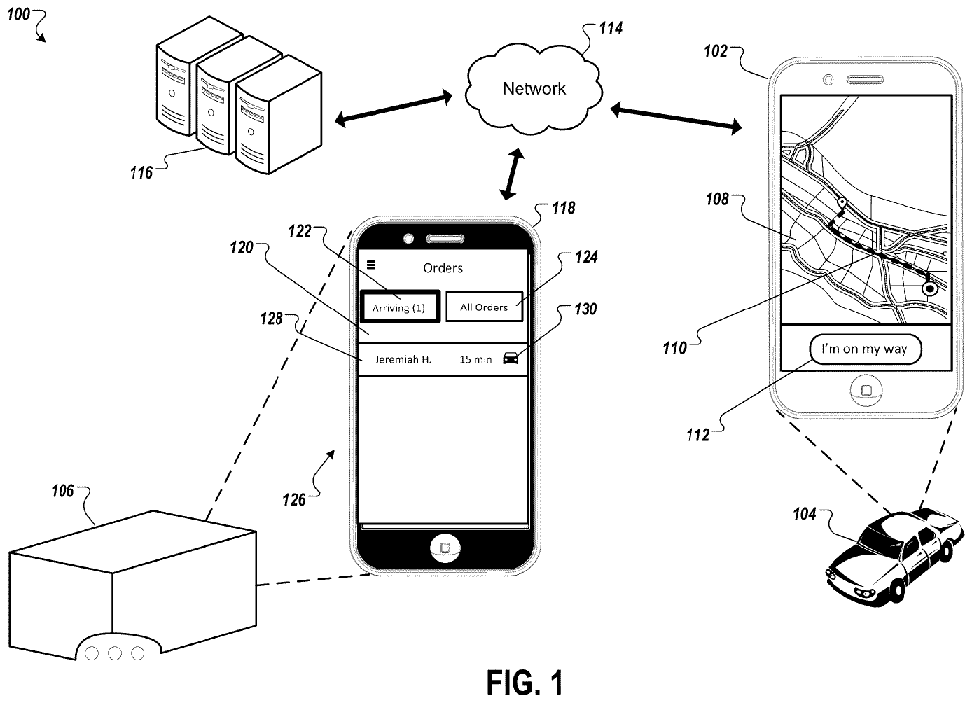

Referring to the figures, FIG. 1 is a diagram of an example system 100 for facilitating items substitutions for user order fulfillment. In the system 100, a customer who wishes to complete an online order for items by picking up the items using a drive-up service can access a dedicated application executing on a mobile device 102. The mobile device 102 can be, for example, a mobile phone, a tablet device, a touch screen computer, a laptop computer, a PDA, a smart watch, or other mobile device. In some implementations, instead of accessing a dedicated application executing on the mobile device 102, the customer can use a browser of the mobile device 102 to access a website that provides the below described functionality. Therefore descriptions related to use of the dedicated application apply equally to a web-based implementation.

The customer can use the dedicated application to select items for purchase from a store or other fulfillment location using an online shopping interface. For example, the dedicated application can be a grocery shopping application that can permit the customer to search and/or browse for grocery items, add desired items to a virtual shopping cart, and place an order for the selected items by entering payment information. The customer can also use the dedicated application to access one or more previously entered orders. For example, a user may have previously logged into an online account for a retailer associated with the dedicated application and placed an on-line order for one or more items using either the mobile device 102 or a different computing device such as a home or laptop computer. As another example, the customer may have previously placed an on-line order using the dedicated application. The customer can access and review the previously placed orders after logging into the dedicated application. This can include reviewing items included in the orders, estimated time until the order is ready, payment used for the order (e.g., “card ending in 123”), a fulfillment location for the order, substitution information, and other information associated with the orders.

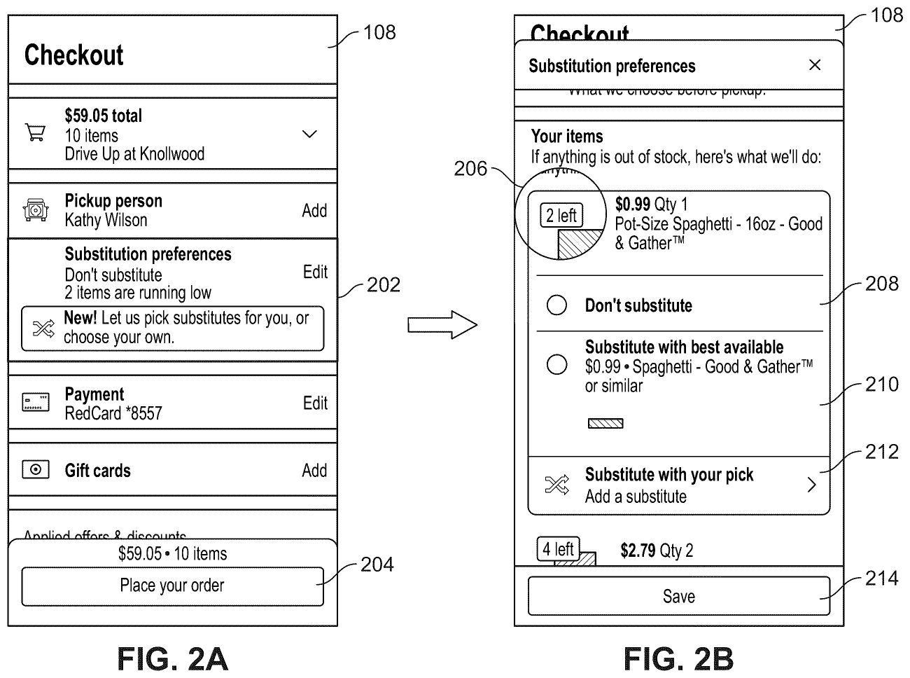

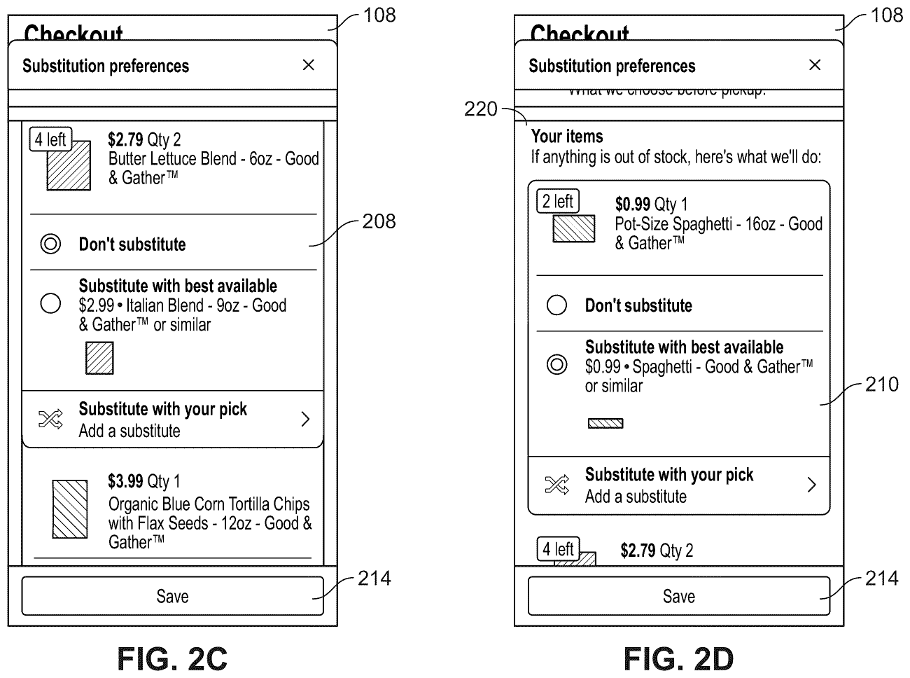

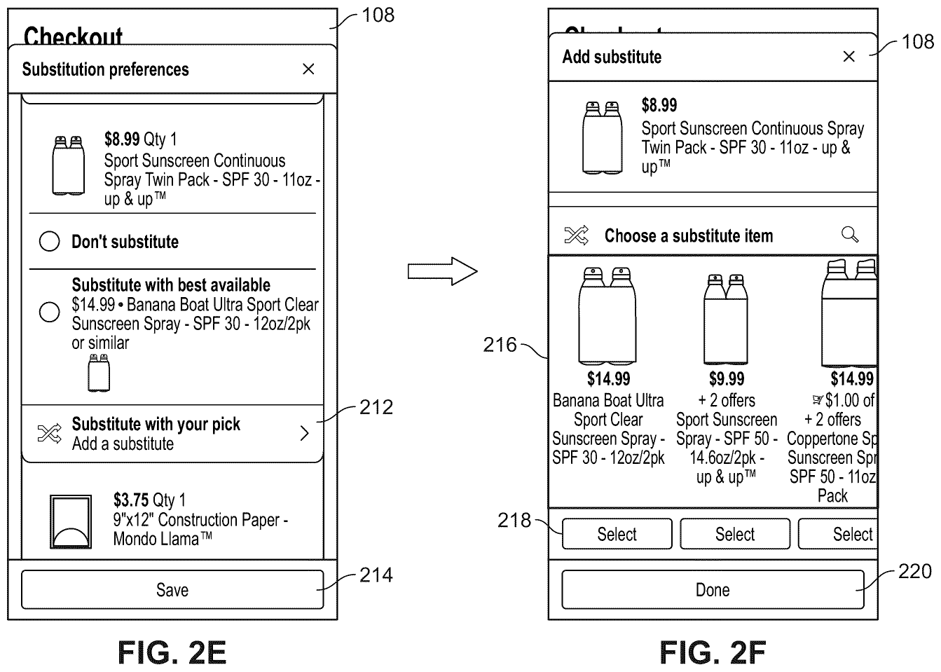

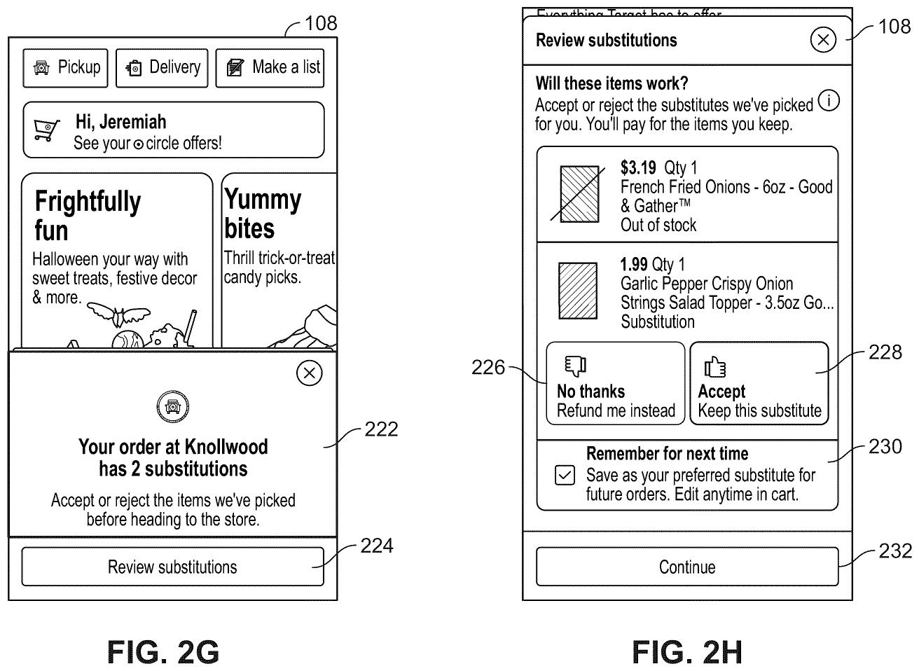

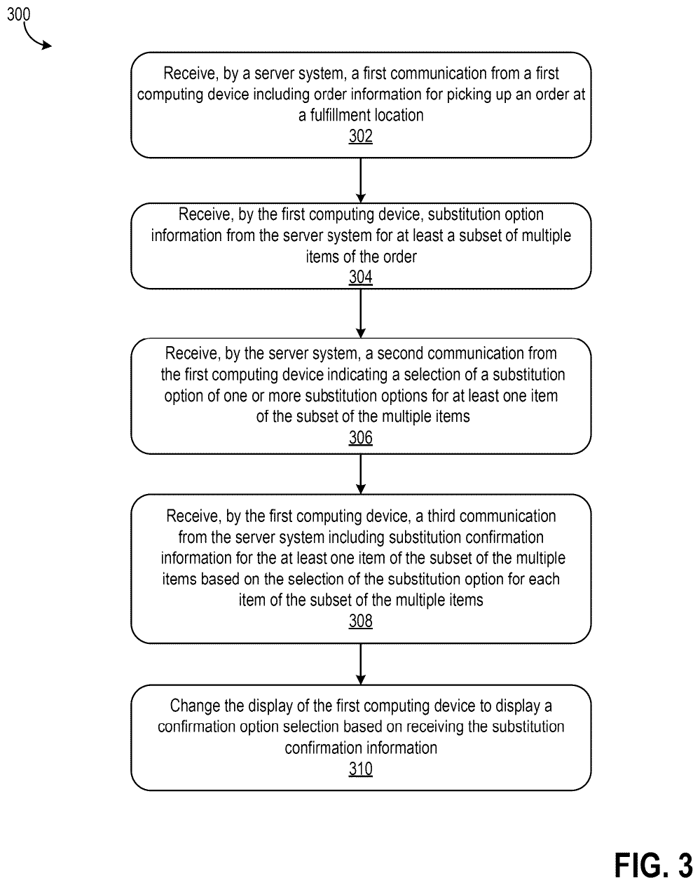

In particular, based on selecting multiple items as part of the online order, the customer can receive substitution option information for a subset of the multiple items from the server system 116. In particular, the substitution option information indicates one or more substitution options for each item of the subset of items, and the customer can select from the one or more substitution options, as described in further detail below with reference to FIGS. 2A-2H and FIG. 3.

The mobile device 102 includes a user interface 108. The user interface 108 can, for example, be a user interface for another dedicated application executing on the mobile device 102. The mobile device 102 can communicate with other computing devices through a network 114, such as, for example, the Internet. For example, the mobile device 102 can communicate with a network access point such as a WiFi router or a cellular communication tower to access the network 114 and communicate with other computing devices. For example, the mobile device 102 can communicate with a server system 116 consisting of one or more servers to place the order. Alternatively, or additionally, the customer can use a different computer to place the order and the different computer can communicate through the network 114 with the server system 116. The server system 116 can be affiliated with a retailer and process the on-line order received from the mobile device 102 or another computing device. The server system 116 can facilitate fulfillment of the order by providing details of the order, such as ordered items, identity of the customer, an order number, time that the order was placed, etc. to one or more computing devices located at a fulfillment center such as a store 106. For example, the store 106 can be part of a chain of affiliated stores associated with a retailer and the server system 116 can be a server system associated with the retailer. Upon receiving an on-line order from the customer, the server system 116 can identify the store 106 as an appropriate fulfillment location for the order based on information such as, an indication of a preferred location for fulfillment indicated by the customer at the mobile device 102 or another computing device, a current location of the mobile device 102, another location associated with the customer (e.g., home or work address information entered by the user into a customer profile), based on item availability (e.g., by identifying a store where all or a majority of the items in the order are in stock), or based on a combination of these and one or more other factors.

For example, the server system 116 can identify the store 106 as an appropriate location for fulfilling the customer's order. The server system 116 can transmit information on the order to a computing device 118 in the possession of, or being used by, a user such as an employee of the store 106. The computing device 118 can be a mobile computing device, such as, for example, a mobile phone, a tablet device, a touch screen computer, a laptop computer, a PDA, a smart watch, or other mobile device. In some implementations, the computing device 118 can be a non-mobile or semi-mobile device such as a server, a desktop computer, a cash register, a smart TV, or other computing device. The server system 116 can provide appropriate information for the order to the computing device 118 such as items in the order, identifying information for the customer who placed the order, time the order was placed, a desired pickup time for the order (e.g., as indicated by the customer at the time of placing the order), an order number, and other relevant information.

At the time of placing the order, or at a different time, such as when logging into the dedicated application, the customer of the mobile device 102 can indicate a desired order fulfillment method for the order. For example, the customer can specify that the order is for drive-up fulfillment. A drive-up fulfillment allows the customer to drive to a fulfillment location, such as a retail store location, a warehouse, or another location where an employee of the retailer can meet the customer at the customer's vehicle 104, verify that the customer is receiving the proper order, and provide the items to the customer without the customer being required to exit their vehicle. For example, the customer can travel to the store 106, park in a designated area of the parking lot of the store 106, notify an employee that they have arrived using the dedicated application, and then receive the purchased items from the employee when the employee brings the items to the customer's vehicle 104.

As another example, the customer can specify that the order is for in-store pickup fulfillment. In-store pickup fulfillment can allow the customer to travel to a fulfillment location, such as the store 106, and enter the store to pick up the purchased items from a designated location within the fulfillment location. Such a fulfillment method can allow the customer greater flexibility by allowing the customer to shop for additional items within the store 106 (e.g., items that the customer wishes to see in-person before purchasing, such as clothing or produce) and then pick up the items from the on-line order at the designated location after completing their in-store shopping. Alternatively, the customer can pick up the order items without also shopping for items at the store 106 in person.

As another example, the customer can specify that the order is for delivery. An employee of the retailer or a third-party service can travel to the customer's home or another drop-off location designated by the customer to deliver the items in the order to the customer.

Prior to picking up the order, the customer can receive substitution confirmation information from the server system 116 from at least one item of the subset of multiple items. In particular, based on a selection of a substitution option by the customer, the customer can receive a notification that indicates an option of whether to accept or reject a substitution for a particular item, as described in further detail below with reference to FIGS. 2A-2H and FIG. 3.

In the case of both drive-up and in-store pickup type order fulfillments, the customer can begin to travel to the fulfillment location, such as by driving the vehicle 104 to the store 106. In some implementations, information collected or generated by the mobile device 102 can be used to determine that the customer has begun to travel to the order fulfillment location. For example, location information determined by the mobile device 102, as described above, can be used to determine that the mobile device 102 has begun to travel along the route 110. For example, the dedicated application can receive location information for the mobile device 102 over sequential periods of time (e.g., every 2 seconds) and compare the movement of the mobile device 102 based on the changing location information to the route 110 to determine that the customer has begun to travel the route 110. Alternatively or additionally, the customer can select a user interface control 112 as part of the user interface 108 provided by the dedicated application to indicate that they have begun traveling toward the store 106. For example, the customer may have selected a permissions setting to not allow the dedicated application to access location information for the mobile device 102. In some implementations, the dedicated application will only display the user interface control 112 in situations in which the customer has not permitted the dedicated application to access location information for the mobile device 102. As another example, the mobile device 102 may be unable to accurately determine its location, for example, due to tall buildings interfering with GPS signals or due to lack of wireless communications access points in the area around the mobile device 102. The dedicated application can provide the user interface control 112 when the mobile device 102 is unable to accurately determine the location of the mobile device 102 so that the customer can indicate that they have begun to travel toward the store 106.

Upon determining that the customer has begun to travel toward the store 106 (e.g., based on location information collected by the mobile device 102 or based on user interaction with the user interface control 112), the mobile device 102 can communicate with one or more computing devices located at and affiliated with the store 106, either directly through the network 114 or by communicating with the server system 116 which in turn communicates appropriate information and instructions to the one or more computing devices located at the store 106. For example, an employee of the store 106 can use the computing device 118, which can receive information relevant to the order from the server system 116. The mobile device 102 can communicate with the server system 116 over the network 114 to indicate to the server system 116 that the customer has begun to travel toward the store 106. The server system 116 can then provide a communication to the computing device 118 of the employee to update information presented at the computing device 118 indicating that the customer of the mobile device 102 is on the way (and thus, that the order for the customer should be prepared and ready for the customer's arrival).

The server system 116 can provide additional information along with this notification or prior to sending the notification that the user is on the way. For example, the server system 116 can provide vehicle identification information to the computing device 118 to allow the employee to more easily identify the customer's vehicle 104 when the customer has arrived at the designating drive-up fulfillment location at the store 106. The server system 116 can also provide information on an estimated time of arrival and/or an estimated time until arrival for the customer. Such timing information can be used to determine ranking of orders to be prepared in a GUI presented at the computing device 118.

The computing device 118 includes a user interface 120. The user interface 120 can, for example, be a user interface for another dedicated application executing on the computing device 118 or another instance of the same dedicated application that is executing on the mobile device 102. The user interface 120 includes a user selectable control 122 that allows the employee to view all arriving orders (e.g., orders for which the user is on the way). The employee can select the control 122 by, for example, using a touch screen interface of the computing device 118 or one or more other input devices of or in communication with the computing device 118. The user interface 120 further includes a control 124 to allow the employee to view all placed orders. This could include all orders placed for fulfillment at the store 106 or all orders assigned specifically to the employee for fulfillment. Selection of the all orders control 124 can cause the user interface 120 to display all orders that have been placed for fulfillment regardless of the user's status (e.g., orders for users that are on the way and orders for users that are not yet on the way).

In the example depicted in FIG. 1, the control 122 is selected and the user interface 120 is displaying a list 126 of orders for which the user is currently on the way and/or has already arrived. For example, an order listing 128 in the list 126 includes the user's name associated with the order, an estimated time until the indicated user is predicted to arrive at the store 106 (15 minutes) and an icon 130 indicating that the user associated with the order listing 128 has selected drive-up order fulfillment. In some implementations, the order listings in the list 126 can include less or more details with respect to each order. For example, each order listing can include an order number. As another example, each order listing can include vehicle identification information.

In some implementations, order listings in the list 126 are user selectable to allow the employee to view additional information about each order (as explained in greater detail below). For example, the employee can select the order listing 128 to cause the user interface 120 to display additional information about the order placed by Jeremiah H. (which can be, for example, the user of mobile device 102). Additional details that can be displayed by the user interface 120 in response to selection of the order listing 128 can include an order number, a listing of items in the order, vehicle identification information, special instructions or requests entered by the customer, location information for bag containing the items for the order (e.g., one or more shelf or bin locations at a drive-up order fulfillment staging area), a number of bags for the order, an indication as to whether or not the order includes age restricted items (e.g., cold medicine, alcohol, etc.), and other information for the order.

When the customer arrives for drive-up or pickup, a barcode or other identifier can be presented at the mobile device 102, which can be scanned by the employee using the computing device 118 and/or a scanning device to verify the customer's identity and verify that the order was provided to the customer. For example, the employee can retrieve the bags for the customer's order from appropriate storage bins located at or near the in-store pickup fulfillment location and provide the bags containing the order to the customer. The employee can then scan the barcode (or otherwise enter an identifier, such as by manually entering into the computing device 118 an ID code or number displayed on the mobile device 102) and the computing device 118 can provide a notification indicating that the scanned or entered code matches the customer or their order to ensure that the employee has provided the correct order. Scanning or entry of the identification code can also cause the computing device 118 to display information indicating that the customer has already paid for the order. In some implementations, another scannable code or identifier, such as a QR code, can be displayed, or a human readable numeric or alphanumeric code can be displayed on the customer's mobile device 102.

In some examples, the server system 116 can maintain substitution for each order and/or for the customer that indicates a selected substitution option, as described in further detail below with reference to FIG. 2H.

FIG. 2A-2H show example user interface displays for computing devices in an order fulfillment system. With respect to FIG. 2A, a user can select controls to start a new order, and a user can select one or more products for purchase. The user can select an option to checkout, and selection of the option to checkout can cause the mobile device 102 to display the user interface 108. The user interface 108 is a user interface displayed by the dedicated application as part of a checkout process for placing an order for pickup. The user interface 108 provides information about the order, including identifying an order subtotal, identifying the number of items in the order (“10 items”), identifying that the order is a drive-up order, a fulfillment location name, a pickup person name, and a payment method for the order. The payment method can be, for example, a pre-stored payment method and the user can change the payment method by selecting a control to change the payment method. Additionally, the user interface 108 includes a control to add one or more gift cards, and a control to view one or more applied offers, discounts, or both.

The user interface 108 further includes a control 202 that indicates substitution option information for a subset of the items of the order based on the items' availability at the fulfillment location (“2 items are running low”). In particular, the server system 116 can transmit an indication of the substitution option information to the user device 102. By selecting the control 202, the user interface 108 can display one or more substitution options for each item of the subset of items, as shown in FIG. 2B. In some implementations, the server system 116 identifies particular items in the user's order that are determined to be running low. For example, the server system 116 can access inventory information for the fulfillment location selected by the user to identify a quantity of units available at the fulfillment location for each item in the user's order. The server system 116 can compare the retrieved inventory information to one or more threshold values to make a determination for each item in the order if that particular item is “running low.” In some implementations, each item in the order can be associated with a different threshold. For example, the “running low” threshold for sunscreen can be selected as five while the “running low” threshold for hats is selected as two. In some implementations, the server system 116 applies the same threshold value (e.g., three) to all items. The server system 116 compares the number of units available at the fulfillment location for each item in the order to the threshold for that item to determine if the item is “running low.” For each item in the order determined to be “running low,” the server system 116 can provide one or more substitution options to the user via the user interface 108, as described in more detail below.

In particular, the user interface 108 of FIG. 2B includes an indication 206 that specifies a number of items available at the fulfillment location for the particular item (e.g., product) (“2 left”). That is, based on the relatively low amount of availability for the item, the user interface 108 can include the multiple substitution option controls 208, 210, and 212, as described in further detail below with reference to FIGS. 2C-2F. In particular, the substitution options can include an option to refrain from substituting the item (“Don't substitute) (e.g., control 208), an option for a second user (e.g., an employee at the fulfillment location) to select a substitute item for the particular item (“Substitute with best available”) (e.g., control 210), and an option for the customer to select a substitute item for the particular item (“Substitute with your pick”) (e.g., control 212).

By allowing customers to select between multiple substitution options, the system allows for more flexibility in substituting items, which can reduce need for the customer to return items after collecting the order, and the customer is able to replace the items efficiently.

In some examples, the system can indicate whether some items are fully eligible for substitutions, partially ineligible for substitutions, or fully ineligible for substitutions. For example, items that are fully eligible for substitutions can include food items, where these items are eligible for the three substitutions options described. In another example, items that are partially eligible can include clothing items, where these items are only eligible for the substitution options of i) refraining from substitution or ii) allowing the customer to select a substitute item. In another example, items that are fully ineligible for substitutions can include alcohol, medication, and the like, where these items are not eligible for any substitutions (e.g., “don't substitute” is automatically selected for such items).

The user interface 108 further includes a control 214 that allows the user to save the selected substitution option for each item of the subset of items (e.g., each item that has a relatively low amount of availability at the fulfillment location).

FIG. 2C shows a selection of the substitution option control 208 of the user interface 108. In this case, a customer can select control 208 to indicate refraining from substituting the identified item (e.g., the item that has relatively low availability at the fulfillment location).

Accordingly, after the customer has saved their selection using control 214 and placed their order, an employee at the fulfillment location will refrain from substituting the particular item. If the item is available, the employee can collect the item for the order. If the item is unavailable, the employee will simply not collect any other item for substitution.

FIG. 2D shows a selection of the substitution option control 210 of the user interface 108. In this case, a customer can select control 210 to indicate that an employee at the fulfillment location can select a substitute item at the fulfillment location. That is, by selecting the control 210, the customer indicates a request for the employee to substitute with a “best available” item that is relatively similar in type, monetary value, and size as the original item. In some examples, as shown in FIG. 2D, the user interface 108 will display a suggested item identified by the server system and provided to the employee's device to guide the employee in selecting the substitute item.

Accordingly, after the customer has saved their selection using control 214 and placed their order, an employee at the fulfillment location can substitute the particular item with a “best available” substitute item if the item is unavailable. In some examples, the “best available” substitute item can be the suggested item displayed in the user interface 108.

FIG. 2E shows a selection of the substitution option control 212 of the user interface 108. In this case, a customer can select control 212 to select a substitution item from available items at the fulfillment location. Based on the selection of the control 212, the user interface 108 can display the one or more suggested substitute item options 216 of FIG. 2F. In particular, the substitute item options 216 can include one or more substitute items that are relatively similar to the original item (e.g., similar in type of item, size, or monetary value) and a respective control 218 for each substitute item. For example, the system may determine a similarity value between the originally selected item and one or more other items based on item description information, item category information, and/or anonymized historical user shopping information indicating item substitutions that customers have made in the past.

In some examples, the substitute item options 216 can also indicate offers for the particular substitute item (“2 offers”), a discount for the particular substitute item (“$1.00 off”), or both.

In this case, the user interface 108 shows three different item options for substitution. Based on reviewing the substitution item options 216, the customer can select one of the substitute item options 216 by interacting with the corresponding control 218 for the item. Based on selecting one of the controls 218, the customer can save their selection by interacting with the control 220.

Accordingly, after the customer has placed their order, an employee at the fulfillment location can substitute the original item with the selected substitute item if the original item is unavailable.

FIG. 2G shows a substitution confirmation notification 222 of the user interface 108 that is displayed once the customer has confirmed and placed their order.

The user interface 108 can be displayed after the customer has placed the order and prior to picking up the order. In particular, the customer can place the order and the corresponding substitution option selections for each identified item of the order (e.g., each item that has relatively low availability at the fulfillment location).

An employee at the fulfillment location can receive information for the order including the substitution option selections at the computing device 118 via the server system 116. The employee can prepare the order based on a current availability of the item at the fulfillment location.

In particular, if the item is available, the employee can prepare the order by collecting the item. If the item is unavailable, the employee can perform preparation of the order based on the selected substitution option for the particular item.

For example, if an item is unavailable and the customer has selected the substitution option control 208, the employee can refrain from substituting the item.

In another example, if the item is unavailable and the customer has selected the substitution control 212, the employee can collect the substitute item 216 selected by the customer.

In another example, if the item is unavailable and the customer has selected the substitution control 210, the employee can select a “best available” substitute item. In some examples, the employee themselves can select the item at their own discretion. In some other examples, the employee can receive an indication from the server system 116 that includes information for possible substitute items based on an item type, a monetary value, or an item size.

In this case, the server system 116 can send the substitution confirmation notification 222 to the user device 102. The substitution confirmation notification 222 can include an indication of an amount of proposed substitute items (“2 substitutions”) for the customer to review (“Accept or reject the items we've picked before heading to the store”). That is, the proposed substitutions are items selected by the employee at the fulfillment location for the one or more items for which the customer selected the substitution option control 210. The customer can select control 224 to review the substitutions for the one or more items.

Based on the selection of the control 212, the user interface 108 can display a confirmation options selection for one or more substitute items of FIG. 2H. In particular, for each item, the user interface 218 can display an indication of the proposed substitute item. Additionally, the user interface 218 can include a rejection control 226 and a confirmation control 228. The customer can select the rejection control 226 to reject the proposed substitute item, and the customer can select the confirmation control 228 to accept the proposed substitute item. In some implementations, when a user selects the rejection control 226, the system will provide instructions to the employee fulfilling the order to not select a substitution for the indicated item. In some implementations, when the user selects the rejection control 226, the system will provide one or more additional substitution options to the user of the device 102.

Based on the customer selecting control 226 or the control 228, the customer can select the control 232 to continue reviewing the proposed substitute items for the order. Once the customer has reviewed the proposed substitute items, the customer can select control 112 to indicate that they are on their way to the fulfillment location to pick up the order. In this way, the customer has an opportunity to review the substitutions prior to arriving at the fulfillment locations, and the employee at the fulfillment location can update the order accordingly.

In some examples, the user interface 108 can include a control 230 that allows the system to maintain a record of the substitution confirmation selection (e.g., control 226 or control 228). That is, the record includes a “preferred” substitute item for future orders. The record can also include the substitution information for each item (e.g., the selected substitution option for items). In some cases, the customer can edit the preferred substitute item using one or more additional screens of the user interface 108.

FIG. 3 is a flowchart of a process 300 to be performed by one or more computing devices in a drive-up fulfillment system.

The process 300 can be performed by the mobile device 102 and the server system 116 depicted and described in reference to FIG. 1. The process 300 can also be performed by one or more other computing systems, devices, computers, networks, cloud-based systems, and/or cloud-based services. For illustrative purposes, the process 300 is described from the perspective of a mobile device.

At 302, the server system receives a first communication from a first computing device including order information for picking up an order at the fulfillment location. The first computing device is associated with an account of a first user, and the order information indicates multiple items. For example, a user of the user interface can interact with the user interface to place an order including multiple items.

At 304, the first computing device receives substitution option information from the server system for at least a subset of multiple items of the order. The substitution option information indicates one or more substitution options for each of the subset of the multiple items. For example, the subset of the multiple items can be based on an availability of the particular item at the fulfillment location, where if there is a relatively low availability of the particular item, the server system can provide the first computing device with the substitution option information for the item with relatively low availability.

At 306, the server system receives a second communication from the first computing device indicating a selection of a substitution option of the one or more substitution options for at least one item of the subset of the multiple items. For example, the first user can interact with the user interface to selection a substitution option of the one or more substitution options for each item of the subset of the multiple items.

In particular, the substitution options include a first substitution option for the first user to select a substitute item for the identified item from multiple items available at the fulfillment location. For example, the first user (e.g., the customer) can themselves select a substitute item from the user interface.

The substitution options further include a second substitution option for a second user to select a substitute item for the identified item from multiple items available at the fulfillment location. The second user is associated with the fulfillment location. The second user can select the substitute item at the fulfillment location based on one or more substitution factors. The one or more substitution factors include a type of the item, a quantity of the item, or a cost of the item. For example, the customer can select so that an employee of the fulfillment location can select a “best” substitute item for the identified item based on a similar cost of the substitute item to the original item selected by the customer.

The substitution options further include a third substitution option to refrain from selecting a substitute item for the identified item. For example, the customer can select for the system not to substitute the identified item.

Based on the user selecting from the substitution options for each item of the subset, the user can select one or more controls of the user interface to place the order at the fulfillment location. In particular, the server system can receive order placement information from the first computing device. The order placement information includes the multiple items and the indications of the substitution option selections. For example, the employee can prepare the order for the customer based on the order information and the item substitution confirmation option.

In some examples, the one or more substitution options for each item of the subset of multiple items are based on an eligibility of the substitution associated with a type of the item. For example, clothing items may only be eligible for the first substitution option and the third substitution option, and alcohol may not be eligible for substitutions (e.g., the third substitution option).

At 308, the first computing device receives a third communication from the server system including substitution confirmation information for the at least one item of the subset of the multiple items based on the selection of the substitution option for each item of the subset of multiple items. For example, based on the user selecting the second substitution option for one or more items of the subset, the user device receives a notification requesting for the user to confirm the substitutions selected by the employee at the fulfillment location prior to picking up the order.

At 310, the system changes a display of the first computing device to display a confirmation option selection based on receiving the substitution confirmation information. For example, the display can provide at least two substitution confirmation options, including confirming the substitution or rejecting the substitution. That is, the customer can select to confirm the substitute item selected by the employee for the order, indicating for the employee to proceed with including the substitute item as part of the order. Alternatively, the customer can select to reject the substitute item selected by the employee for the order, indicating for the employee to refrain from including substitute item as part of the order.

In some examples, the server system can receive a fourth communication from the first computing device indicating that the first computing device has arrived at the fulfillment location to pick up the order. The order information includes a unique identifier associated with the account of the first user.

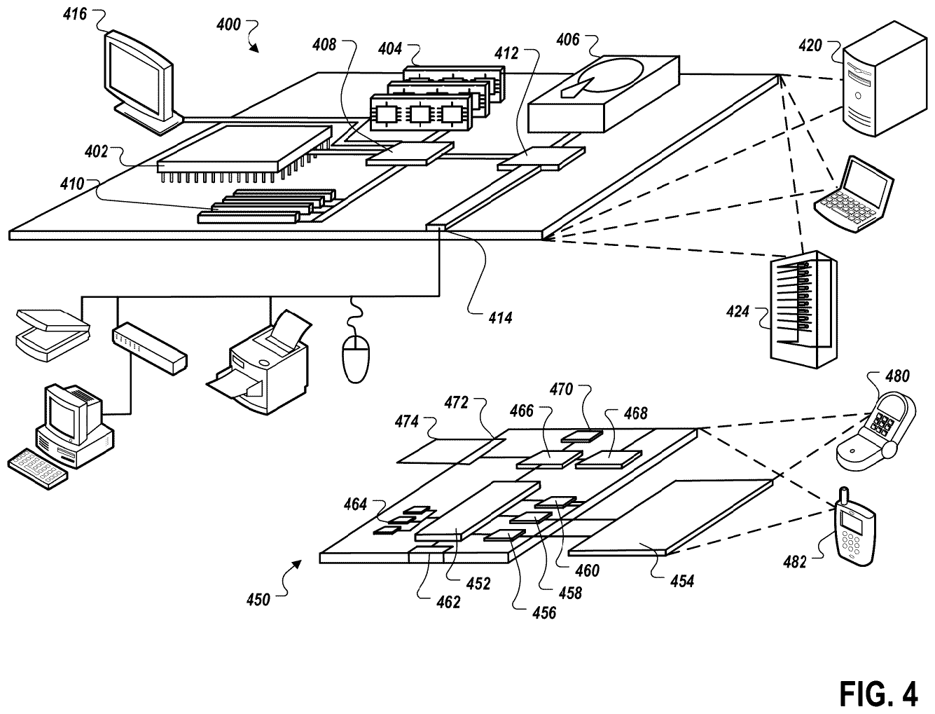

FIG. 4 shows an example of a computing device 400 and an example of a mobile computing device that can be used to implement the techniques described here. The computing device 400 is intended to represent various forms of digital computers, such as laptops, desktops, workstations, personal digital assistants, servers, blade servers, mainframes, and other appropriate computers. The mobile computing device is intended to represent various forms of mobile devices, such as personal digital assistants, cellular telephones, smart-phones, and other similar computing devices. The components shown here, their connections and relationships, and their functions, are meant to be exemplary only, and are not meant to limit implementations of the inventions described and/or claimed in this document.

The computing device 400 includes a processor 402, a memory 404, a storage device 406, a high-speed interface 408 connecting to the memory 404 and multiple high-speed expansion ports 410, and a low-speed interface 412 connecting to a low-speed expansion port 414 and the storage device 406. Each of the processor 402, the memory 404, the storage device 406, the high-speed interface 408, the high-speed expansion ports 410, and the low-speed interface 412, are interconnected using various busses, and can be mounted on a common motherboard or in other manners as appropriate. The processor 402 can process instructions for execution within the computing device 400, including instructions stored in the memory 404 or on the storage device 406 to display graphical information for a GUI on an external input/output device, such as a display 416 coupled to the high-speed interface 408. In other implementations, multiple processors and/or multiple buses can be used, as appropriate, along with multiple memories and types of memory. Also, multiple computing devices can be connected, with each device providing portions of the necessary operations (e.g., as a server bank, a group of blade servers, or a multi-processor system).

The memory 404 stores information within the computing device 400. In some implementations, the memory 404 is a volatile memory unit or units. In some implementations, the memory 404 is a non-volatile memory unit or units. The memory 404 can also be another form of computer-readable medium, such as a magnetic or optical disk.

The storage device 406 is capable of providing mass storage for the computing device 400. In some implementations, the storage device 406 can be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product can also contain instructions that, when executed, perform one or more methods, such as those described above. The computer program product can also be tangibly embodied in a computer-or machine-readable medium, such as the memory 404, the storage device 406, or memory on the processor 402.

The high-speed interface 408 manages bandwidth-intensive operations for the computing device 400, while the low-speed interface 412 manages lower bandwidth-intensive operations. Such allocation of functions is exemplary only. In some implementations, the high-speed interface 408 is coupled to the memory 404, the display 416 (e.g., through a graphics processor or accelerator), and to the high-speed expansion ports 410, which can accept various expansion cards (not shown). In the implementation, the low-speed interface 412 is coupled to the storage device 406 and the low-speed expansion port 414. The low-speed expansion port 414, which can include various communication ports (e.g., USB, Bluetooth, Ethernet, wireless Ethernet) can be coupled to one or more input/output devices, such as a keyboard, a pointing device, a scanner, or a networking device such as a switch or router, e.g., through a network adapter.

The computing device 400 can be implemented in a number of different forms, as shown in the figure. For example, it can be implemented as a standard server 420, or multiple times in a group of such servers. In addition, it can be implemented in a personal computer such as a laptop computer 422. It can also be implemented as part of a rack server system 424. Alternatively, components from the computing device 400 can be combined with other components in a mobile device (not shown), such as a mobile computing device 450. Each of such devices can contain one or more of the computing device 400 and the mobile computing device 450, and an entire system can be made up of multiple computing devices communicating with each other.

The mobile computing device 450 includes a processor 452, a memory 464, an input/output device such as a display 454, a communication interface 466, and a transceiver 468, among other components. The mobile computing device 450 can also be provided with a storage device, such as a micro-drive or other device, to provide additional storage. Each of the processor 452, the memory 464, the display 454, the communication interface 466, and the transceiver 468, are interconnected using various buses, and several of the components can be mounted on a common motherboard or in other manners as appropriate.

The processor 452 can execute instructions within the mobile computing device 450, including instructions stored in the memory 464. The processor 452 can be implemented as a chipset of chips that include separate and multiple analog and digital processors. The processor 452 can provide, for example, for coordination of the other components of the mobile computing device 450, such as control of user interfaces, applications run by the mobile computing device 450, and wireless communication by the mobile computing device 450.

The processor 452 can communicate with a user through a control interface 458 and a display interface 456 coupled to the display 454. The display 454 can be, for example, a TFT (Thin-Film-Transistor Liquid Crystal Display) display or an OLED (Organic Light Emitting Diode) display, or other appropriate display technology. The display interface 456 can comprise appropriate circuitry for driving the display 454 to present graphical and other information to a user. The control interface 458 can receive commands from a user and convert them for submission to the processor 452. In addition, an external interface 462 can provide communication with the processor 452, so as to enable near area communication of the mobile computing device 450 with other devices. The external interface 462 can provide, for example, for wired communication in some implementations, or for wireless communication in other implementations, and multiple interfaces can also be used.

The memory 464 stores information within the mobile computing device 450. The memory 464 can be implemented as one or more of a computer-readable medium or media, a volatile memory unit or units, or a non-volatile memory unit or units. An expansion memory 474 can also be provided and connected to the mobile computing device 450 through an expansion interface 472, which can include, for example, a SIMM (Single In Line Memory Module) card interface. The expansion memory 474 can provide extra storage space for the mobile computing device 450, or can also store applications or other information for the mobile computing device 450. Specifically, the expansion memory 474 can include instructions to carry out or supplement the processes described above, and can include secure information also. Thus, for example, the expansion memory 474 can be provide as a security module for the mobile computing device 450, and can be programmed with instructions that permit secure use of the mobile computing device 450. In addition, secure applications can be provided via the SIMM cards, along with additional information, such as placing identifying information on the SIMM card in a non-hackable manner.

The memory can include, for example, flash memory and/or NVRAM memory (non-volatile random access memory), as discussed below. In some implementations, a computer program product is tangibly embodied in an information carrier. The computer program product contains instructions that, when executed, perform one or more methods, such as those described above. The computer program product can be a computer-or machine-readable medium, such as the memory 464, the expansion memory 474, or memory on the processor 452. In some implementations, the computer program product can be received in a propagated signal, for example, over the transceiver 468 or the external interface 462.

The mobile computing device 450 can communicate wirelessly through the communication interface 466, which can include digital signal processing circuitry where necessary. The communication interface 466 can provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication can occur, for example, through the transceiver 468 using a radio-frequency. In addition, short-range communication can occur, such as using a Bluetooth, WiFi, or other such transceiver (not shown). In addition, a GPS (Global Positioning System) receiver module 470 can provide additional navigation-and location-related wireless data to the mobile computing device 450, which can be used as appropriate by applications running on the mobile computing device 450.

The mobile computing device 450 can also communicate audibly using an audio codec 460, which can receive spoken information from a user and convert it to usable digital information. The audio codec 460 can likewise generate audible sound for a user, such as through a speaker, e.g., in a handset of the mobile computing device 450. Such sound can include sound from voice telephone calls, can include recorded sound (e.g., voice messages, music files, etc.) and can also include sound generated by applications operating on the mobile computing device 450.

The mobile computing device 450 can be implemented in a number of different forms, as shown in the figure. For example, it can be implemented as a cellular telephone 480. It can also be implemented as part of a smart-phone 482, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of the disclosed technology or of what may be claimed, but rather as descriptions of features that may be specific to particular embodiments of particular disclosed technologies. Certain features that are described in this specification in the context of separate embodiments can also be implemented in combination in a single embodiment in part or in whole. Conversely, various features that are described in the context of a single embodiment can also be implemented in multiple embodiments separately or in any suitable subcombination. Moreover, although features may be described herein as acting in certain combinations and/or initially claimed as such, one or more features from a claimed combination can in some cases be excised from the combination, and the claimed combination may be directed to a subcombination or variation of a subcombination. Similarly, while operations may be described in a particular order, this should not be understood as requiring that such operations be performed in the particular order or in sequential order, or that all operations be performed, to achieve desirable results. Particular embodiments of the subject matter have been described. Other embodiments are within the scope of the following claims.

What is claimed is:

1. A computer implemented method comprising:
receiving, by a server system, a first communication from a first computing device including order information for picking up an order at a fulfillment location, wherein the first computing device is associated with an account of a first user, and wherein the order information indicates a plurality of items;
receiving, by the first computing device, substitution option information from the server system for at least a subset of the plurality of items of the order, wherein the substitution option information indicates one or more substitution options for each of the subset of the plurality of items;
receiving, by the server system, a second communication from the first computing device indicating a selection of a substitution option of the one or more substitution options for at least one item of the subset of the plurality of items;
receiving, by the first computing device, a third communication from the server system including substitution confirmation information for the at least one item of the subset of the plurality of items based on the selection of the substitution option for each item of the subset of the plurality of items; and
changing a display of the first computing device to display a confirmation option selection based on receiving the substitution confirmation information.

2. The computer implemented method of claim 1, wherein receiving, by the first computing device, substitution option information from the server system for at least a subset of the plurality of items of the order comprises:
identifying each item of the subset of the plurality of items based on an availability of the item at the fulfillment location.

3. The computer implemented method of claim 1, wherein the one or more substitution options for each item of the subset of the plurality of items are based on an eligibility of the substitution associated with a type of the item.

4. The computer implemented method of claim 1, wherein the one or more substitution options include:
a first substitution option for the first user to select a substitute item for an identified item from a plurality of items available at the fulfillment location,
a second substitution option for a second user to select a substitute item for the identified item from a plurality of items available at the fulfillment location, wherein the second user is associated with the fulfillment location,
a third substitution option to refrain from selecting a substitute item for the identified item,
or a combination thereof.

5. The computer implemented method of claim 4, wherein receiving, by the server system, a second communication from the first computing device indicating a selection of a substitution option of the one or more substitution options for each at least one of the subset of the plurality of items comprises:
selecting, by the first user, a substitution option for each of the subset of the plurality of items; and
receiving, by the server system, order placement information from the first computing device, wherein the order placement information includes the plurality of items and the indications of the substitution option selections.

6. The computer implemented method of claim 5, further comprising:
receiving, by a second computing device, the order placement information of the first user from the server system, wherein the second computing device is associated with the second user at the fulfillment location.

7. The computer implemented method of claim 6, wherein receiving, by a second computing device, the order placement information of the first user from the server system comprises:
receiving, by the second computing device, the order placement information indicating one or more selections of the second substitution option for one or more items of the subset of the plurality of items;
selecting, by the second user, for each item, the substitute item at the fulfillment location based on one or more substitution factors; and
transmitting, to the first computing device, the substitution confirmation information for each of the at least one item of the subset of the plurality of items, wherein the substitution confirmation information indicates each substitute item selected by the second user for the order.

8. The computer implemented method of claim 7, wherein the one or more substitution factors include a type of the item, a quantity of the item, a cost of the item, or a combination thereof.

9. The computer implemented method of claim 7, further comprising:
selecting, by a first user, an item substitution confirmation option for each substitute item selected by the second user for the order;
receiving, by the second computing device, the item substitution confirmation option; and preparing, by the second user, the order for the first user based on the order information and the item substitution confirmation option.

10. The computer implemented method of claim 9, wherein selecting, by a first user, an item substitution confirmation option for each substitute item selected by the second user for the order comprises:
selecting, by the first user, to confirm the substitute item selected by the second user for the order, wherein the confirming indicates to substitute the item with the substitute item selected by the second user.

11. The computer implemented method of claim 9, wherein selecting, by a first user, an item substitution confirmation option for each substitute item selected by the second user for the order comprises:
selecting, by the first user, to reject the substitute item selected by the second user for the order, wherein the rejecting indicates to refrain from substituting the item with the substitute item selected by the second user.

12. The computer implemented method of claim 1, further comprising:
maintaining substitution information for each order, wherein the substitution information indicates, for each item, the selected substitution option.

13. The computer implemented method of claim 12, wherein the substitution information further indicates the substitute item selected by the first user based on a selection of the first substitution option, the substitute item selected by the second user based on a selection of the second substitution option, or both.

14. The computer implemented method of claim 13, wherein the substitution information further indicates, for each substitute item selected by the second user, the item substitution confirmation option selected by the first user for the substitute item selected by the second user.

15. The method of claim 1, further comprising:
receiving, by the server system, a fourth communication from the first computing device indicating that the first computing device has arrived at the fulfillment location to pick up the order.

16. The method of claim 1, wherein the order information includes an identifier associated with the account of the first user.

17. A system comprising:
one or more processors; and computer memory containing instructions that, when executed by the one or more processors, cause the system to perform operations comprising:
receiving, by a server system, a first communication from a first computing device including order information for picking up an order at a fulfillment location, wherein the first computing device is associated with an account of a first user, and wherein the order information indicates a plurality of items;
receiving, by the first computing device, substitution option information from the server system for at least a subset of the plurality of items of the order, wherein the substitution option information indicates one or more substitution options for each of the subset of the plurality of items;
receiving, by the server system, a second communication from the first computing device indicating a selection of a substitution option of the one or more substitution options for at least one item of the subset of the plurality of items;
receiving, by the first computing device, a third communication from the server system including substitution confirmation information for the at least one item of the subset of the plurality of items based on the selection of the substitution option for each item of the subset of the plurality of items; and
changing a display of the first computing device to display a confirmation option selection based on receiving the substitution confirmation information.
